(19) United States
(12) Patent Application Publication
(10) Pub. No.: US 2019/0356145 A1
(43) Pub. Date: Nov. 21, 2019

(54) ELECTRONIC CIGARETTE AND BATTERY PROTECTION CIRCUIT THEREOF

(71) Applicant: Changzhou Patent Electronic Technology Co., LTD, Changzhou, Jiangsu (CN)

(72) Inventor: Weihua QIU, Changzhou, Jiangsu (CN)

(21) Appl. No.: 16/477,842

(22) PCT Filed: Oct. 24, 2017
(86) PCT No.: PCT/CN2017/107449

§ 371 Date: Jul. 12, 2019

(30) Foreign Application Priority Data
Jan. 13, 2017 (CN) 201710025393.5

(51) Int. Cl. H02J 7/00; H01M 2/34; A24F 47/00

(52) U.S. Cl. CPC H02J 7/0034; H02J 7/0016; A24F 47/008; H01M 2/34

(57) ABSTRACT

An electronic cigarette and a battery protection circuit thereof. The battery protection circuit is used for connecting with a battery. The battery protection circuit has a first connecting end and a second connecting end, the first connecting end being connected with one terminal of a battery and the second connecting end being connected with the other terminal of the battery. The battery protection circuit further comprises a third connecting end, a fourth connecting end, a fifth connecting end, and a sixth connecting end, the third connecting end and the fourth connecting end being both used for connecting with a positive voltage source, and the fifth connecting end and the sixth connecting end being both used for connecting with ground.

### FIELD OF TECHNOLOGY

The invention relates to the technical field of smoke simulation, and more particularly, relates to an electronic cigarette and a battery protection circuit of the electronic cigarette.

### BACKGROUND

Conventional electronic cigarette can be powered on to work only if a battery is installed properly in a forward direction. When the battery is connected reversely, the electronic cigarette is powered off and cannot work, and the battery can be burned out immediately if a USB (Universal Serial Bus) is plugged to the electronic cigarette for charging the battery. For the electronic cigarette having a replaceable battery or having an non-replacement battery, in order to avoid a reverse assembly of the battery, the consumer and the producer should be cautious when assembling the battery. Particularly for the electronic cigarette having the replaceable battery, if the user assembles the battery in the dark or under a poor lighting, the battery may be assembled reversely, causing the battery or the product to be damaged due to a reverse assembly.

### SUMMARY

Accordingly, it is necessary to provide a battery protection circuit that can provide a voltage output or a voltage input, that when the battery is assembled via either in a forward connection or in a reverse connection, permitting a protection of the battery and the circuit.

Further, an electronic cigarette is provided.

A battery protection circuit is configured for connecting with a battery. The battery protection circuit includes: a first connecting end configured to connect with a terminal of the battery; a second connecting end configured to connect with an opposite terminal of the battery; a third connecting end; a fourth connecting end; a fifth connecting end, and a sixth connecting end; wherein the third connecting end and the fourth connecting end are both configured for connecting with a positive voltage source, the fifth connecting end and the sixth connecting end are both configured for connecting with ground, when the first connecting end is connected to a positive terminal of the battery, and the second connecting end is connected to a negative terminal of the battery, then the third connecting end is connected to the first connecting end, and the fifth connecting end is connected to the second connecting end; when the first connecting end is connected to the negative terminal of the battery, and the second connecting end is connected to the positive terminal of the battery, then the sixth connecting end is connected to the first connecting end, and the fourth connecting end is connected to the second connecting end.

According to one embodiment, the battery protection circuit includes a first switch, a second switch, a third switch, and a fourth switch, which all have three ends, the three ends of each switch includes a first end, a second end, and a control end, a conduction between the first end and the second end is controlled by the control end, and determined by a potential of the control end, a connection between first switch and the fourth switch is conducted by a high potential, and is cutoff by a low potential, a connection between the second switch and the third switch is conducted by a low potential, and is cutoff by a high potential;

in the first switch, the first end acts as the third connecting end and is connected to the positive voltage source, the second end and the control end are both connected to the first connecting end;

in the second switch, the first end acts as the sixth connecting end and is connected to the ground, the second end and the control end are both connected to the first connecting end;

in the third switch, the first end acts as the fifth connecting end and is connected to the ground, the second end and the control end are both connected to the second connecting end;

in the fourth switch, the first end acts as the fourth connecting end and is connected to the positive voltage source, the second end and the control end are both connected to the second connecting end.

According to one embodiment, both the first switch and the fourth switch are NMOS transistors, the first end is a source terminal, the second end is a drain terminal, and the control end is a gate terminal; both the second switch and the third switch are PMOS transistors, the first end is a source terminal, the second end is a drain terminal, the control end is a gate terminal.

According to one embodiment, each of the first switch and the fourth switch adopts a AON6512 chip, wherein, the 1-3 pins of the AON6512 chip acting as the first switch are all led out to act as the third connecting end and connect with the positive voltage source, the 4-8 pins are all connected to the first connecting end; the 1-3 pins of the AON6512 chip acting as the fourth switch are all led out to act as the fourth connecting end and connect with the positive voltage source, the 4-8 pins are all connected to the second connecting end;

each of the second switch and the third switch adopts a AON6411 chip, wherein, the 1-3 pins of the AON6411 chip acting as the second switch are all led out to act as the sixth connecting end and connect with the ground, the 4-8 pins are all connected to the first connecting end; the 1-3 pins of the AON6411 chip acting as the third switch are all led out to act as the fifth connecting end and connect with the ground, the 4-8 pins are all connected to the second connecting end.

According to one embodiment, the battery protection circuit includes a first relay switch module and a second relay switch module, wherein the first relay switch module includes a first coil and a first switch, and the second relay switch module includes a second coil and a second switch;

opposite ends of the first coil are connected to the first connecting end and the second connecting end, respectively, the normally open contact of the first switch acts as the third connecting end and is connected to the positive voltage source, the normally closed contact acts as the sixth connecting end and is connected to the ground, the common contact is connected to the first connecting end;

opposite ends of the second coil are connected to the first connecting end and the second connecting end, respectively, the normally open contact of the second switch acts as the fifth connecting end and is connected to the ground, the normally closed contact acts as the fourth connecting end and is connected to the positive voltage source, the common contact is connected to the second connecting end;

wherein, the first connecting end is connected to the first coil and the second coil via a first anti-reverse diode, the positive terminal of the first anti-reverse diode is connected to the first connecting end.

An electronic cigarette, including a master control circuit, an atomizing circuit, and an aforementioned battery protection circuit, the battery protection circuit is configured to connect with the battery, for providing power for the master control circuit and the atomizing circuit.

According to one embodiment, the electronic cigarette further includes the battery, wherein the positive terminal of the battery is connected to the first connecting end of the battery protection circuit, the negative terminal of the battery is connected to the second connecting end of the battery protection circuit, or, the positive terminal of the battery is connected to the second connecting end of the battery protection circuit, the negative terminal of the battery is connected to the first connecting end of the battery protection circuit.

According to one embodiment, the battery is detachably or fixedly connected to the battery protection circuit.

According to one embodiment, wherein the battery is a rechargeable battery.

According to one embodiment, a receiving case and a battery case are further included, wherein the battery case is configured for receiving the battery, the battery case forms two first interfaces which are same as each other in the battery case, the two first interfaces are respectively led out from the positive terminal and the negative terminal of the battery, the receiving case is connected to the first connecting end and the second connecting end of the battery protection circuit, the receiving case forms two second interfaces which are same as each other in the receiving case, the two second interfaces are respectively led from the first connecting end and the second connecting end into an interior of the receiving case; the battery case is positioned in the receiving case, the first interfaces are connected to the second interfaces to enabling the battery case to connect with the receiving case.

When the positive terminal of the battery is connected to the first connecting end, and the negative terminal of the battery is connected to the second connecting end, the control end C of the first switch is conducted due to an input of a high potential, the control end C of the second switch is cut off due to an input of a high potential, the control end C of the third switch is conducted due to an input of a low potential, the control end C of the fourth switch is cut off due to an input of a low potential. Therefore, the battery outputs a voltage by the first switch and the third switch.

When the negative terminal of the battery is connected to the first connecting end, and the positive terminal of the battery is connected to the second connecting end, the control end C of the first switch is cut off due to an input of a low potential, the control end C of the second switch is conducted due to an input of a low potential, the control end C of the third switch is cut off due to an input of a high potential, the control end C of the fourth switch is conducted due to an input of a high potential. Therefore, the battery outputs a voltage by the second switch and the fourth switch. Thus the battery protection circuit can provide power for the electronic cigarette no matter the battery are assembled in by any ways, a damage due to a reverse connection can be effectively avoided.

### BRIEF DESCRIPTION OF THE DRAWINGS

FIG. 1a and FIG. 1b are a functional schematic of a battery protection circuit according an embodiment;

FIG. 2 is a block diagram of a battery protection circuit according an embodiment;

FIG. 3 is a circuit diagram of a switch in FIG. 2 which adopts MOS transistors;

FIG. 4 is circuit diagram of a switch in FIG. 2 which adopts chips;

FIG. 5 is a block diagram of a battery protection circuit according another embodiment;

FIG. 6 is a block diagram of an electronic cigarette according to an embodiment;

FIG. 7 is a schematic diagram of a battery case and a receiving case.

### DETAILED DESCRIPTION OF THE PREFERRED EMBODIMENT

Embodiments of the disclosure are described more fully hereinafter with reference to the accompanying drawings.

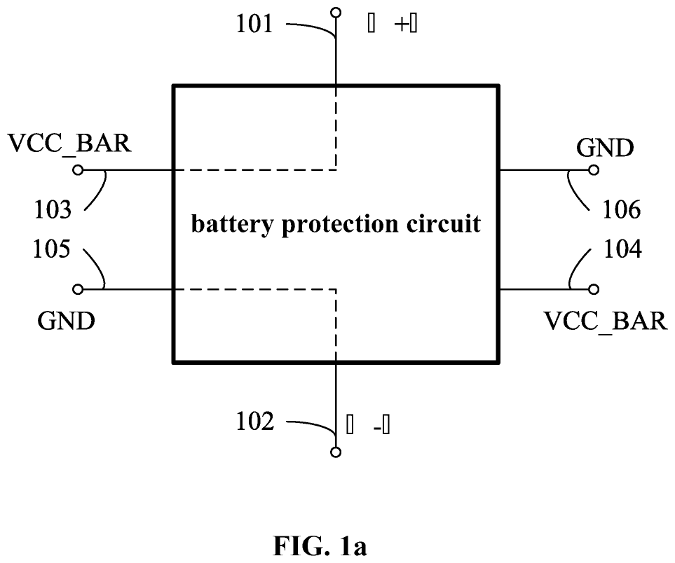

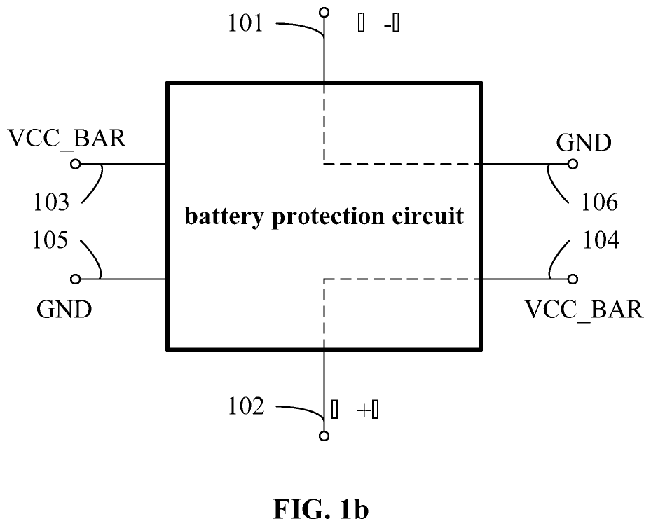

FIG. 1a and FIG. 1b relate to a functional schematic diagram of a battery protection circuit according to an embodiment. The battery protection circuit 10 includes a first connecting end 101, a second connecting end 102, a third connecting end 103, a fourth connecting end 104, a fifth connecting end 105, and a sixth connecting end 106. The battery protection circuit 10 is configured for connecting with a battery.

The third connecting end 103 and the fourth connecting end 104 are both configured for connecting with a positive voltage source VCC_BAR, the fifth connecting end 105 and the sixth connecting end 106 are both configured for connecting with ground GND.

As shown in FIG. 1a, when the first connecting end 101 is connected to the positive terminal (+) of the battery, and the second connecting end 102 is connected to the negative terminal (−) of the battery. Then the third connecting end 103 is connected to the first connecting end 101, and the fifth connecting end 105 is connected to the second connecting end 102.

As shown in FIG. 1b, when the first connecting end 101 is connected to the negative terminal (−) of the battery, and the second connecting end 102 is connected to the positive terminal (+) of the battery. Then the sixth connecting end 106 is connected to the first connecting end 101, and the fourth connecting end 104 is connected to the second connecting end 102.

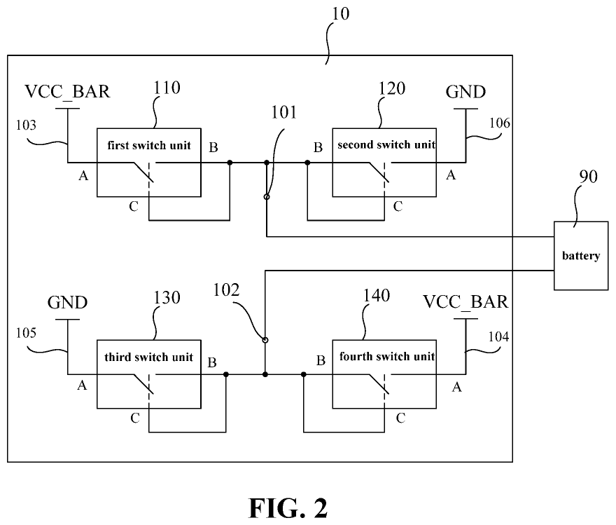

FIG. 2 shows a block diagram of a battery protection circuit according to an embodiment. The battery protection circuit 10 is configured for connecting with a battery 90. The first connecting end 101 is connected to a terminal of the battery 90, the second connecting end 102 is connected to an opposite end of the battery 90.

The battery protection circuit 10 includes a first switch 110, a second switch 120, a third switch 130, and a fourth switch 140, which all have three ends. The three ends of each switch include a first end A, a second end B, and a control end C. A conduction between the first end A and the second end B is controlled by the control end C, and determined by a potential of the control end C. A connection between first switch 110 and the fourth switch 140 is conducted by a high potential, and is cutoff by a low potential. A connection between the second switch 120 and the third switch 130 is conducted by a low potential, and is cutoff by a high potential.

As shown in FIG. 2, the first end A of the first switch 110 acts as the third connecting end 103 and is connected to the positive voltage source VCC_BAR, the second end B and the control end C are both connected to the first connecting end 101. The first end A of the second switch 120 acts as the sixth connecting end 106 and is connected to the ground GND, the second end B and the control end C are both connected to the first connecting end 101.

The first end A of the third switch 130 acts as the fifth connecting end 105 and is connected to the ground GND, the second end B and the control end C are both connected to the second connecting end 102. The first end A of the fourth switch 140 acts as the fourth connecting end 104 and is connected to the positive voltage source VCC_BAR, the second end B and the control end C are both connected to the second connecting end 102.

When the positive terminal of the battery 90 is connected to the first connecting end 101, and the negative terminal of the battery 90 is connected to the second connecting end 102, the control end C of the first switch 110 is conducted due to an input of a high potential, the control end C of the second switch 120 is cut off due to an input of a high potential, the control end C of the third switch 130 is conducted due to an input of a low potential, the control end C of the fourth switch 140 is cut off due to an input of a low potential. Therefore, the battery 90 outputs a voltage by the first switch 110 and the third switch 130, i.e. the battery 90 outputs a voltage via the third connecting end 103 and the fifth connecting end 105.

When the negative terminal of the battery 90 is connected to the first connecting end 101, and the positive terminal of the battery 90 is connected to the second connecting end 102, the control end C of the first switch 110 is cut off due to an input of a low potential, the control end C of the second switch 120 is conducted due to an input of a low potential, the control end C of the third switch 130 is cut off due to an input of a high potential, the control end C of the fourth switch 140 is conducted due to an input of a high potential. Therefore, the battery 90 outputs a voltage by the second switch 120 and the fourth switch 140, i.e. the battery 90 outputs a voltage via the fourth connecting end 104 and the sixth connecting end 106.

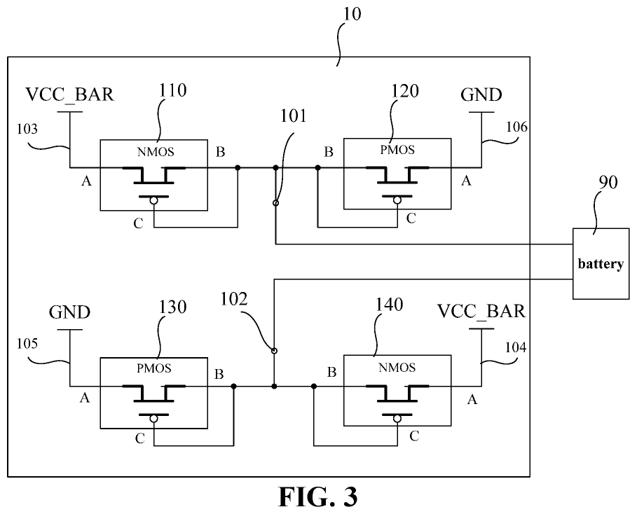

According to one embodiment, as shown in FIG. 3, the first switch 110 and the fourth switch 140 can both be NMOS transistors, the first end A is a source terminal S, the second end B is a drain terminal D, the control end C is a gate terminal G. The second switch 120 and the third switch 130 can both be PMOS transistors, the first end A is a source terminal S, the second end B is a drain terminal D, the control end C is a gate terminal G.

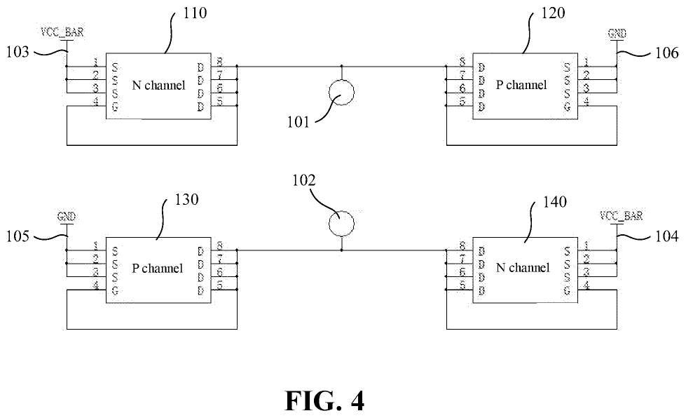

According to one embodiment, as shown in FIG. 4, each of the first switch 110 and the fourth switch 140 adopts an AON6512 chip, in which the 1-3 pins of the AON6512 chip acts as the first switch 110 are all led out to act as the third connecting end 103 and connect with the positive voltage source VCC_BAR, the 4-8 pins are all connected to the first connecting end 101. The 1-3 pins of the AON6512 chip acting as the fourth switch 140 are all led out to act as the fourth connecting end 104 and connect with the positive voltage source VCC_BAR, the 4-8 pins are all connected to the second connecting end 102. Each of the second switch 120 and the third switch 130 adopts a AON6411 chip, in which the 1-3 pins of the AON6411 chip acta as the second switch 120 are all led out to act as the sixth connecting end 106 and connect with the ground GND, the 4-8 pins are all connected to the first connecting end 101. The 1-3 pins of the AON6411 chip acting as the third switch 130 are all led out to act as the fifth connecting end 105 and connect with the ground GND, the 4-8 pins are all connected to the second connecting end 102

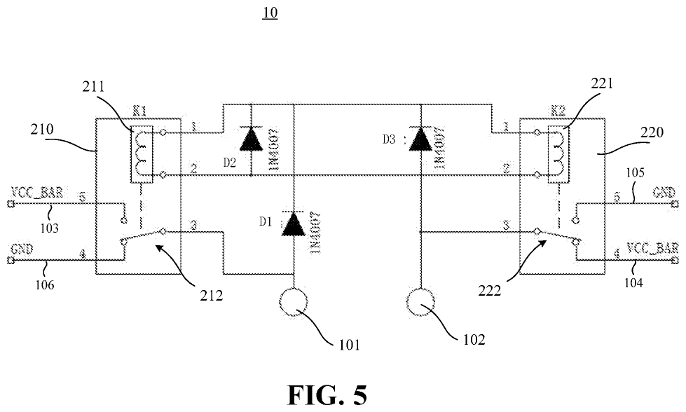

FIG. 5 shows a block diagram of a battery protection circuit according to an alternative embodiment. The battery protection circuit 10 includes a first relay switch module 210 and a second relay switch module 220. The first relay switch module 210 includes a first coil 211 and a first switch 212, and the second relay switch module 220 includes a second coil 221 and a second switch 222.

Opposite ends of the first coil 211 are connected to the first connecting end 101 and the second connecting end 102, respectively. The normally open contact of the first switch 212 acts as the third connecting end 103 and is connected to the positive voltage source VCC_BAR. The normally closed contact acts as the sixth connecting end 106 and is connected to the ground GND. The common contact is connected to the first connecting end 101.

Opposite ends of the second coil 221 are connected to the first connecting end 101 and the second connecting end 102, respectively. The normally open contact of the second switch 222 acts as the fifth connecting end 105 and is connected to the ground GND, the normally closed contact acts as the fourth connecting end 104 and is connected to the positive voltage source VCC_BAR, the common contact is connected to the second connecting end 102.

The first connecting end 101 is connected to the first coil 211 and the second coil 221 via a first anti-reverse diode D1, the positive terminal of the first anti-reverse diode D1 is connected to the first connecting end 101.

The first coil 211 is magnetically connected to the first switch 212, the second coil 221 is magnetically connected to the second switch 222. Further, in actual implementations, the first coil 211 is adjacent to the normal open contact of the first switch 212. Similarly, the second coil 221 is adjacent to the normal open contact of the second switch 222.

When the first connecting end 101 is connected to the positive terminal of the battery, and the second connecting end 102 is connected to the negative terminal of the battery, then the current flows from the first connecting end 101 (the positive terminal of the battery), and flows to the first coil 211 and the second coil 221 via the first anti-reverse diode D1. The current finally flows back to the second connecting end 102 (the negative terminal of the battery), and a loop is thereby formed. An electro-magnetic induction is generated when the current flows through the first coil 211, a flexure strip of the first switch 212 is sucked to the normally open contact, thereby, the first relay switch module 210 connects the positive terminal of the battery with the positive voltage source VCC_BAR via the third connecting end 103. At the same time, an electro-magnetic induction is generated when the current flows through the second coil 221, the flexure strip of the second switch 222 contacts the normally open contact, thereby, the second relay switch module 220 connects the negative terminal of the battery with the ground GND via the fifth connecting end 105.

When the first connecting end 101 is connected to the negative terminal of the battery, and the second connecting end 102 is connected the positive terminal of the battery, then the current cannot flow to the first coil 211 and the second coil 221 via the first anti-reverse diode D1. The flexure strip of the first switch 212 remains normally closed. Therefore, the first relay switch module 210 connects the negative terminal of the battery with the ground GND via the sixth connecting end 106. At the same time, the flexure strip of the second switch 222 remains normally closed. Therefore, the second relay switch module 220 connects the positive terminal of the battery with the positive voltage source VCC_BAR via the fourth connecting end 104.

Aforementioned battery protection circuit 10 can be applied to electronic cigarette or other electronic appliances. An electronic cigarette according to one embodiment is provided as follows:

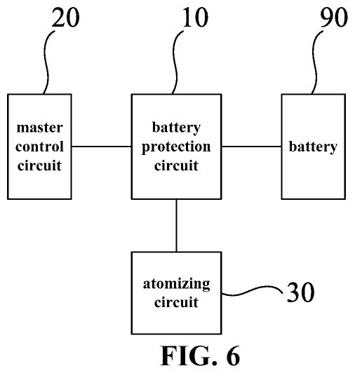

As shown in FIG. 6, an electronic cigarette according to an embodiment includes aforementioned battery protection circuit 10, a master control circuit 20, and an atomizing circuit. The battery protection circuit 10 is configured for connecting with the battery 90 for providing power for the master control circuit 20 and the atomizing circuit 30.

Aforementioned electronic cigarette can further include a battery 90, the positive terminal of the battery 90 is connected to the first connecting end 101 of the battery protection circuit 10, the negative terminal of the battery 90 is connected to the second connecting end 102 of the battery protection circuit 10. Or, the positive terminal of the battery 90 is connected to the second connecting end 102 of the battery protection circuit 10, the negative terminal of the battery 90 is connected to the first connecting end 101 of the battery protection circuit 10. The battery protection circuit 10 can provide power for the electronic cigarette when the battery protection circuit 10 is connected to the positive terminal and the negative terminal of the battery 90 by any ways.

The battery 90 is detachably or fixedly connected to the battery protection circuit 10. The detachable connection is suitable for replacing the battery, aforementioned battery protection circuit 10 can prevent user from a reverse assembly of the battery. The fixable connection is suitable for the situation that a replacement of the battery is not permitted, aforementioned battery protection circuit 10 can prevent a reverse assembly of the battery in the production process, and an assembly efficiency is enhanced. The battery 90 can be a rechargeable battery. The rechargeable battery is suitable for being detachably or fixedly connected in the electronic cigarette.

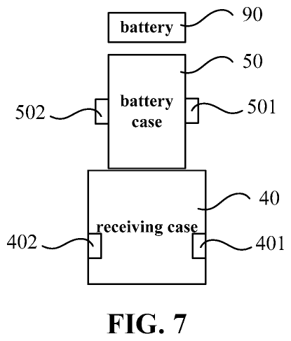

Further, as shown in FIG. 7, aforementioned electronic cigarette can further include a receiving case 40 and a battery case 50. The battery case 50 is configured for receiving the battery 90. The battery case 50 forms two first interfaces 501, 502 which are same as each other in the battery case 50. The two first interfaces 501, 502 are respectively led out from the positive terminal and the negative terminal of the battery 90. The receiving case 40 is connected to the first connecting end 101 and the second connecting end 102 of the battery protection circuit 10. The receiving case 40 forms two second interfaces 401, 402, which are same as each other in the receiving case 40. The two second interfaces 401, 402 are respectively led from the first connecting end 101 and the second connecting end 102 into the interior of the receiving case 40. The first interfaces 501, 502 of the battery case 50 are connected to the second interfaces 401, 402 of the receiving case 40, thus enabling the battery case 50 to be positioned in the receiving case 40. The battery can be a button cell or a cylinder battery. Accordingly, the battery case 50 has a shape and a structure that suitable for receiving the button cell or the cylinder battery.

By adopting aforementioned structure, the battery case 50 has an inner structure adaptable for the positive terminal and the negative terminal of the battery, and the outer structure of the battery case 50 has a commonly used shape and structure. When the battery case 50 is assembled to the receiving case 40, it can be assembled without considering which direction the battery case 50 is moved, the assembly process is simple and convenient.

Various technical features of the above embodiments can be combined in any manner. For clarity of description, all possible combinations of various technical features of the above embodiments are not described. However, as long as combinations of these technical features do not contradict with each other, they should be regarded within the scope described in the present specification.

The embodiments described above are merely preferred embodiments, but not intended to limit the application. Any modifications, alternatives or improvements made within the principle and spirit of the present application should be interpreted as falling within the protection scope of the present application. The claims are not limited to the features or acts described above. Rather, the proper scope of the disclosure is defined by the appended claims.

1-10. (canceled)

11. A battery protection circuit, configured for connecting with a battery, comprising:
a first connecting end configured to connect with a terminal of the battery;
a second connecting end configured to connect with an opposite terminal of the battery;
a third connecting end;
a fourth connecting end;
a fifth connecting end, and
a sixth connecting end;
wherein the third connecting end and the fourth connecting end are both configured for connecting with a positive voltage source, the fifth connecting end and the sixth connecting end are both configured for connecting with ground, when the first connecting end is connected to a positive terminal of the battery, and the second connecting end is connected to a negative terminal of the battery, then the third connecting end is connected to the first connecting end, and the fifth connecting end is connected to the second connecting end; when the first connecting end is connected to the negative terminal of the battery, and the second connecting end is connected to the positive terminal of the battery, then the sixth connecting end is connected to the first connecting end, and the fourth connecting end is connected to the second connecting end.

12. The battery protection circuit according to claim 11, wherein the battery protection circuit comprises a first switch, a second switch, a third switch, and a fourth switch, which all have three ends, the three ends of each switch comprises a first end, a second end, and a control end, a conduction between the first end and the second end is controlled by the control end, and determined by a potential of the control end, a connection between first switch and the fourth switch is conducted by a high potential, and is cutoff by a low potential, a connection between the second switch and the third switch is conducted by a low potential, and is cutoff by a high potential;
in the first switch, the first end acts as the third connecting end and is connected to the positive voltage source, the second end and the control end are both connected to the first connecting end;
in the second switch, the first end acts as the sixth connecting end and is connected to the ground, the second end and the control end are both connected to the first connecting end;
in the third switch, the first end acts as the fifth connecting end and is connected to the ground, the second end and the control end are both connected to the second connecting end;
in the fourth switch, the first end acts as the fourth connecting end and is connected to the positive voltage source, the second end and the control end are both connected to the second connecting end.

13. The battery protection circuit according to claim 12, wherein both the first switch and the fourth switch are NMOS transistors, the first end is a source terminal, the second end is a drain terminal, and the control end is a gate terminal; both the second switch and the third switch are PMOS transistors, the first end is a source terminal, the second end is a drain terminal, the control end is a gate terminal.

14. The battery protection circuit according to claim 13, wherein each of the first switch and the fourth switch adopts a AON6512 chip, wherein, the 1-3 pins of the AON6512 chip acting as the first switch are all led out to act as the third connecting end and connect with the positive voltage source, the 4-8 pins are all connected to the first connecting end; the 1-3 pins of the AON6512 chip acting as the fourth switch are all led out to act as the fourth connecting end and connect with the positive voltage source, the 4-8 pins are all connected to the second connecting end;
each of the second switch and the third switch adopts a AON6411 chip, wherein, the 1-3 pins of the AON6411 chip acting as the second switch are all led out to act as the sixth connecting end and connect with the ground, the 4-8 pins are all connected to the first connecting end; the 1-3 pins of the AON6411 chip acting as the third switch are all led out to act as the fifth connecting end and connect with the ground, the 4-8 pins are all connected to the second connecting end.

15. The battery protection circuit according to claim 11, comprising a first relay switch module and a second relay switch module, wherein the first relay switch module comprises a first coil and a first switch, and the second relay switch module comprises a second coil and a second switch;
opposite ends of the first coil are connected to the first connecting end and the second connecting end, respectively, the normally open contact of the first switch acts as the third connecting end and is connected to the positive voltage source, the normally closed contact acts as the sixth connecting end and is connected to the ground, the common contact is connected to the first connecting end;
opposite ends of the second coil are connected to the first connecting end and the second connecting end, respectively, the normally open contact of the second switch acts as the fifth connecting end and is connected to the ground, the normally closed contact acts as the fourth connecting end and is connected to the positive voltage source, the common contact is connected to the second connecting end;
wherein, the first connecting end is connected to the first coil and the second coil via a first anti-reverse diode, the positive terminal of the first anti-reverse diode is connected to the first connecting end.

16. An electronic cigarette, comprising a master control circuit, an atomizing circuit, and a battery protection circuit, the battery protection circuit is configured to connect with the battery, for providing power for the master control circuit and the atomizing circuit.

17. The electronic cigarette according to claim 16, wherein the battery protection circuit, configured for connecting with a battery, comprising a first connecting end configured to connect with a terminal of the battery;
a second connecting end configured to connect with an opposite terminal of the battery;
a third connecting end;
a fourth connecting end;
a fifth connecting end, and
a sixth connecting end;
wherein the third connecting end and the fourth connecting end are both configured for connecting with a positive voltage source, the fifth connecting end and the sixth connecting end are both configured for connecting with ground, when the first connecting end is connected to a positive terminal of the battery, and the second connecting end is connected to a negative terminal of the battery, then the third connecting end is connected to the first connecting end, and the fifth connecting end is connected to the second connecting end; when the first connecting end is connected to the negative terminal of the battery, and the second connecting end is connected to the positive terminal of the battery, then the sixth connecting end is connected to the first connecting end, and the fourth connecting end is connected to the second connecting end.

18. The electronic cigarette according to claim 17, wherein the battery protection circuit comprises a first switch, a second switch, a third switch, and a fourth switch, which all have three ends, the three ends of each switch comprises a first end, a second end, and a control end, a conduction between the first end and the second end is controlled by the control end, and determined by a potential of the control end, a connection between first switch and the fourth switch is conducted by a high potential, and is cutoff by a low potential, a connection between the second switch and the third switch is conducted by a low potential, and is cutoff by a high potential;
in the first switch, the first end acts as the third connecting end and is connected to the positive voltage source, the second end and the control end are both connected to the first connecting end;
in the second switch, the first end acts as the sixth connecting end and is connected to the ground, the second end and the control end are both connected to the first connecting end;
in the third switch, the first end acts as the fifth connecting end and is connected to the ground, the second end and the control end are both connected to the second connecting end;
in the fourth switch, the first end acts as the fourth connecting end and is connected to the positive voltage source, the second end and the control end are both connected to the second connecting end.

19. The electronic cigarette according to claim 18, wherein both the first switch and the fourth switch are NMOS transistors, the first end is a source terminal, the second end is a drain terminal, and the control end is a gate terminal; both the second switch and the third switch are PMOS transistors, the first end is a source terminal, the second end is a drain terminal, the control end is a gate terminal.

20. The electronic cigarette according to claim 17, comprising a first relay switch module and a second relay switch module, wherein the first relay switch module comprises a first coil and a first switch, and the second relay switch module comprises a second coil and a second switch;
opposite ends of the first coil are connected to the first connecting end and the second connecting end, respectively, the normally open contact of the first switch acts as the third connecting end and is connected to the positive voltage source, the normally closed contact acts as the sixth connecting end and is connected to the ground, the common contact is connected to the first connecting end;
opposite ends of the second coil are connected to the first connecting end and the second connecting end, respectively, the normally open contact of the second switch acts as the fifth connecting end and is connected to the ground, the normally closed contact acts as the fourth connecting end and is connected to the positive voltage source, the common contact is connected to the second connecting end;
wherein, the first connecting end is connected to the first coil and the second coil via a first anti-reverse diode, the positive terminal of the first anti-reverse diode is connected to the first connecting end.

21. The electronic cigarette according to claim 17, further comprising the battery, wherein the positive terminal of the battery is connected to the first connecting end of the battery protection circuit and the negative terminal of the battery is connected to the second connecting end of the battery protection circuit, or, the positive terminal of the battery is connected to the second connecting end of the battery protection circuit and the negative terminal of the battery is connected to the first connecting end of the battery protection circuit.

22. The electronic cigarette according to claim 17, wherein the battery is detachably or fixedly connected to the battery protection circuit.

23. The electronic cigarette according to claim 17, wherein the battery is a rechargeable battery.

24. The electronic cigarette according to claim 17, further comprising a receiving case and a battery case, wherein the battery case is configured for receiving the battery, the battery case forms two first interfaces which are same as each other in the battery case, the two first interfaces are respectively led out from the positive terminal and the negative terminal of the battery, the receiving case is connected to the first connecting end and the second connecting end of the battery protection circuit, the receiving case forms two second interfaces which are same as each other in the receiving case, the two second interfaces are respectively led from the first connecting end and the second connecting end into an interior of the receiving case; the battery case is positioned in the receiving case, the first interfaces are connected to the second interfaces to enabling the battery case to connect with the receiving case.

25. An electronic cigarette, comprising a master control circuit, an atomizing circuit, and a battery protection circuit, wherein the battery protection circuit is configured to supply power to the main control circuit and the atomization circuit when a battery is installed either in a forward direction or in a reverse direction.

26. The electronic cigarette according to claim 25, wherein the battery protection circuit, configured for connecting with the battery, comprising:
a first connecting end configured to connect with a terminal of the battery;
a second connecting end configured to connect with an opposite terminal of the battery;
a third connecting end;
a fourth connecting end;
a fifth connecting end, and
a sixth connecting end;
wherein the third connecting end and the fourth connecting end are both configured for connecting with a positive voltage source, the fifth connecting end and the sixth connecting end are both configured for connecting with ground, when the first connecting end is connected to a positive terminal of the battery, and the second connecting end is connected to a negative terminal of the battery, then the third connecting end is connected to the first connecting end, and the fifth connecting end is connected to the second connecting end; when the first connecting end is connected to the negative terminal of the battery, and the second connecting end is connected to the positive terminal of the battery, then the sixth connecting end is connected to the first connecting end, and the fourth connecting end is connected to the second connecting end.

27. The electronic cigarette according to claim 25, wherein the battery protection circuit comprises a first switch, a second switch, a third switch, and a fourth switch, which all have three ends, the three ends of each switch comprises a first end, a second end, and a control end, a conduction between the first end and the second end is controlled by the control end, and determined by a potential of the control end, a connection between first switch and the fourth switch is conducted by a high potential, and is cutoff by a low potential, a connection between the second switch and the third switch is conducted by a low potential, and is cutoff by a high potential;
in the first switch, the first end acts as the third connecting end and is connected to the positive voltage source, the second end and the control end are both connected to the first connecting end;
in the second switch, the first end acts as the sixth connecting end and is connected to the ground, the second end and the control end are both connected to the first connecting end;
in the third switch, the first end acts as the fifth connecting end and is connected to the ground, the second end and the control end are both connected to the second connecting end;
in the fourth switch, the first end acts as the fourth connecting end and is connected to the positive voltage source, the second end and the control end are both connected to the second connecting end.

28. The electronic cigarette according to claim 27, wherein both the first switch and the fourth switch are NMOS transistors, the first end is a source terminal, the second end is a drain terminal, and the control end is a gate terminal; both the second switch and the third switch are PMOS transistors, the first end is a source terminal, the second end is a drain terminal, the control end is a gate terminal.

29. The electronic cigarette according to claim 26, comprising a first relay switch module and a second relay switch module, wherein the first relay switch module comprises a first coil and a first switch, and the second relay switch module comprises a second coil and a second switch; opposite ends of the first coil are connected to the first connecting end and the second connecting end, respectively, the normally open contact of the first switch acts as the third connecting end and is connected to the positive voltage source, the normally closed contact acts as the sixth connecting end and is connected to the ground, the common contact is connected to the first connecting end;
opposite ends of the second coil are connected to the first connecting end and the second connecting end, respectively, the normally open contact of the second switch acts as the fifth connecting end and is connected to the ground, the normally closed contact acts as the fourth connecting end and is connected to the positive voltage source, the common contact is connected to the second connecting end;
wherein, the first connecting end is connected to the first coil and the second coil via a first anti-reverse diode, the positive terminal of the first anti-reverse diode is connected to the first connecting end.

30. The electronic cigarette according to claim 26, further comprising the battery, wherein the positive terminal of the battery is connected to the first connecting end of the battery protection circuit, the negative terminal of the battery is connected to the second connecting end of the battery protection circuit, or, the positive terminal of the battery is connected to the second connecting end of the battery protection circuit, the negative terminal of the battery is connected to the first connecting end of the battery protection circuit.
